(19) United States
(12) Patent Application Publication
(10) Pub. No.: US 2013/0216784 A1
(43) Pub. Date: Aug. 22, 2013

(54) SUPERHYDROPHOBIC FILMS

(71) Applicants: Jun-Ying Zhang, Perrysburg, OH (US); Terry L. Smith, Roseville, MN (US); Katherine A. Brown, Lake Elmo, MN (US); Vivian W. Jones, Woodbury, MN (US); David K. Sayler, Roseville, MN (US); Timothy J. Hebrink, Scandia, MN (US); Qingbing Wang, Woodbury, MN (US); Karan Jindal, Woodbury, MN (US); Encai Hao, Woodbury, MN (US)

(72) Inventors: Jun-Ying Zhang, Perrysburg, OH (US); Terry L. Smith, Roseville, MN (US); Katherine A. Brown, Lake Elmo, MN (US); Vivian W. Jones, Woodbury, MN (US); David K. Sayler, Roseville, MN (US); Timothy J. Hebrink, Scandia, MN (US); Qingbing Wang, Woodbury, MN (US); Karan Jindal, Woodbury, MN (US); Encai Hao, Woodbury, MN (US)

(73) Assignee: 3M INNOVATIVE PROPERTIES COMPANY, St. Paul, MN (US)

(21) Appl. No.: 13/882,098

(22) PCT Filed: Oct. 20, 2011
(86) PCT No.: PCT/US11/57073

§ 371 Date: Apr. 26, 2013

Related U.S. Application Data
(60) Provisional application No. 61/407,820, filed on Oct. 28, 2010.

(51) Int. Cl. B08B 17/06

(52) U.S. Cl. CPC B08B 17/065
USPC 428/147; 428/141; 428/143; 216/41; 216/51

(57) ABSTRACT

Superhydrophobic films (200, 400) are disclosed. More particularly, durable superhydrophobic films (200, 400) having discrete flat faces (206, 406) spaced apart by valleys (208, 408) where the valleys and faces are covered by nanostructures or nanoparticles (424) are disclosed. Various methods of making such films are also disclosed.

### CROSS REFERENCE TO RELATED APPLICATIONS

The present application relates generally to the following co-filed and commonly assigned U.S. Patent Applications: “Superhydrophobic Film Constructions”, Attorney Docket No. 66910US002, and “Superhydrophobic Films”, Attorney Docket No. 66911US002, each of which is incorporated herein by reference in its entirety.

### FIELD

The present description relates to superhydrophobic films and methods of making such films. More particularly, the present description relates to durable superhydrophobic films having a surface with discrete flat portions and valleys and different methods of producing such films.

### BACKGROUND

Hydrophobic films and coatings, and more particularly, superhydrophobic films and coatings have garnered considerable attention in recent years due to a number of attractive qualities. Highly hydrophobic surfaces have been recognized in nature, perhaps most prevalently on lotus leaves and also on cicada wings. Because of its hydrophobic properties, the lotus leaf is capable of self-cleaning by the washing away of dust particles and debris as water droplets roll off its surface. This ability to self-clean is desirable in a number of modern-day applications. However, it may be difficult to produce a self-cleaning superhydrophobic film that is capable of extended use in certain environments. The current description provides a superhydrophobic film that has a surface that is highly durable and weatherable in variable conditions, for example, outdoors, and performs very effectively without serious performance concerns after abrasive exposure.

### SUMMARY

In one aspect, the present description relates to a superhydrophobic film having a first major surface and a second major surface opposite the first major surface. The second major surface of the film has an array of discrete flat surface portions substantially parallel to the first major surface, and also has an array of valleys, where each valley is positioned between two adjacent discrete flat surface portions. Each of the discrete flat surface portions and valleys has a plurality of nanofeatures, and the superhydrophobic film exhibits a water contact angle of at least 140 degrees and a sliding angle of less than 10 degrees.

In another aspect, the present description relates to a superhydrophobic film having a first major surface, a second major surface, and a low surface energy coating. The second major surface of the film has an array of discrete flat surface portions substantially parallel to the first major surface, and also has an array of valleys, where each valley is positioned between two adjacent discrete flat surface portions. The low surface energy coating is applied to the array of discrete flat surface portions and array of valleys, and is made up, in part, of nanoparticles. The superhydrophobic film exhibits a water contact angle of at least 140 degrees and a sliding angle of less than 10 degrees.

In another aspect, the present description relates to one more method of producing a superhydrophobic film. The method includes a step of providing a structured film that has a first major surface and a second major surface opposite the first major surface. The second major surface may include a plurality of microstructures, where at least some of the microstructures have a discrete flat surface portion on the top of the microstructure, the discrete flat surface portions being substantially parallel to the first major surface. The method further includes applying a fluorochemical coating to the second major surface. The fluorochemical coating includes a plurality of nanoparticles. The film may be provided by replication from a mold having valleys with at least some flat bases.

In a final aspect, the present description relates to a method of producing a superhydrophobic film. The method includes a step of providing a structured film that has a first major surface and a second major surface opposite the first major surface. The second major surface may include a plurality of microstructures, where at least some of the microstructures have a discrete flat surface portion on the top of the microstructure, the discrete flat surface portions being substantially parallel to the first major surface. The method further includes the step of applying a layer of nanoparticles to the second major surface. Next, the second major surface is etched using the layer of nanoparticles as an etch mask. The result is a plurality of nanostructures on the discrete flat surface portions and remainder of the microstructures.

### BRIEF DESCRIPTION OF THE DRAWINGS

FIGS. 1a-b are flow charts of superhydrophobic films that are degraded over time due to abrasion on microstructure surfaces.

FIG. 2 is a cross-sectional view of a superhydrophobic film according to the present description.

FIGS. 3a-b are cross sectional views of films with different microstructure spacing intervals.

FIG. 4 is a cross-sectional view of a superhydrophobic film according to the present description.

FIGS. 5a-c are cross-sectional views of films with different valley shapes.

FIGS. 6a-6d provide illustrations of water droplets as related to measuring water contact angle, advancing angle, and receding angle.

FIG. 7 is an apparatus for durability testing films.

FIG. 8 illustrates a method for creating superhydrophobic films according to the present description.

FIG. 9 illustrates a method for creating superhydrophobic films according to the present description.

FIG. 10 is a cross-sectional view of superhydrophobic film with different microstructure shapes.

FIG. 11 illustrates dimensional aspects of a cross-section of superhydrophobic film.

FIGS. 12a-c are different microstructure distributions for a superhydrophobic film.

### DETAILED DESCRIPTION

Superhydrophobic films and surfaces are very desirable in a number of applications due to their ability to self-clean. Generally, a film may be considered “superhydrophobic” where the water contact angle is greater than 140 degrees. Superhydrophobic films may further be understood as generally nonwettable, as water beads off of the surface of the film upon contact. A further desirable quality for such films may be low contact angle hysteresis, that is, a small difference between the advancing and receding contact angles of the water droplet. A low contact angle hysteresis, or “sliding angle” allows for water beads to roll off of the surface of a film or other construction more easily. The combination of the ability to bead water that comes into contact with the surface of a structure and further roll the beaded water off of the surface is what makes the surface “self-cleaning.”

This ability to self-clean is desirable in a number of modern-day applications. For example, self-cleaning superhydrophobic surfaces may be useful on the sun-facing surfaces of solar (photovoltaic) cells, in anti-icing applications, corrosion prevention, anti-condensation applications, wind blades, traffic signals, edge seals, anti-fouling applications, and drag reduction and/or noise reduction for automobiles, aircraft, boats and microfluidic devices, just to name a few. Such films may also have valuable anti-reflection properties. There have therefore been attempts to create superhydrophobic films either by microstructuring a film's surface in a manner resembling that of the lotus leaf, coating the film with a hydrophobic chemical coating, or a combination thereof. Unfortunately, a number of these attempts have resulted in films that are not sufficiently durable in outdoor or other harsh environments. This is especially unfortunate due to the difficult conditions to which such films are exposed in the exemplary applications noted. Those attempts at producing films that are durable in harsh application environments may not display the highly superhydrophobic properties that are necessary for optimal self-cleaning performance. The present description therefore provides an improvement by offering a superhydrophobic film that is highly durable and weatherable in harsh conditions, for example, long-term use outdoors, and performs very effectively, even without a surface coating.

In addition, an increasing number of applications require a superhydrophobic film construction that is transparent to visible or near-visible light. Besides having very superhydrophobic performance, the currently described films may exhibit very low reflectivity and therefore be highly transmissive. This is a highly beneficial property for applications where films are applied to solar cells, or any sort of window or light transmissive usage where the films are used for self-cleaning or anti-icing properties. The films described herein may reflect less than 5% of incident light, and may reflect less than 2% of incident light. In some application, only approximately 1% of light incident on the films is reflected.

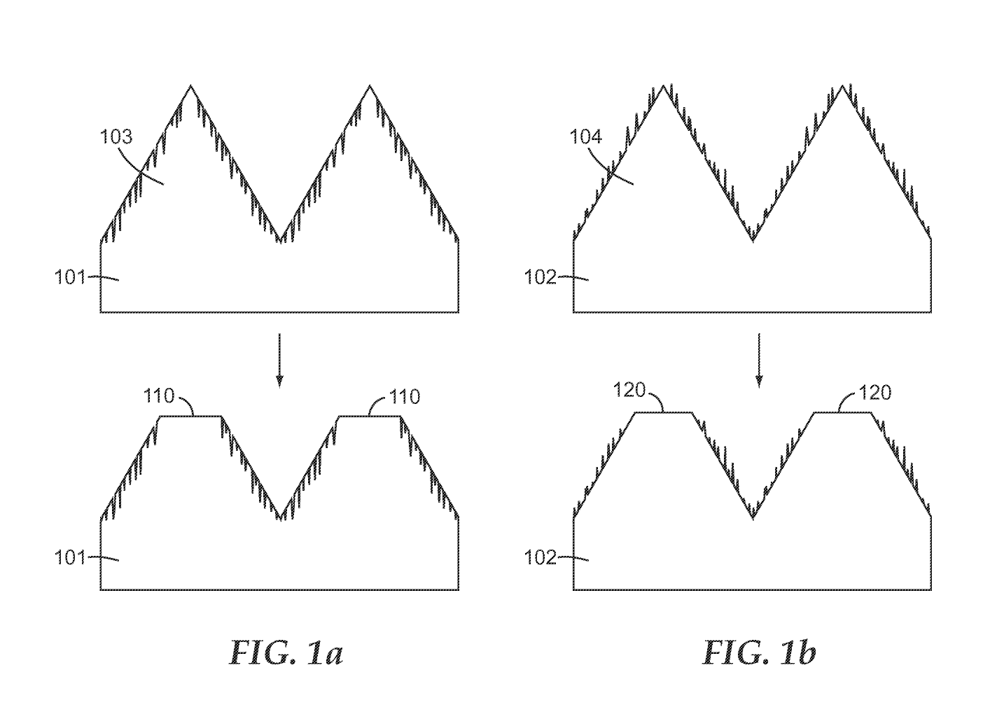

A number of superhydrophobic films may derive their superhydrophobic properties from the fact that they have microstructures or microparticles that are overlaid with nanostructures or nanoparticles. A great deal of difficulty arises, however, in preserving the nanoparticles or nanostructures on or near the peaks of the microstructures of the film as they degrade over time. An example of this effect is illustrated in FIG. 1. Here, nanostructures or nanocavities are formed into the microstructures 103 and 104. However, after abrasive wear and tear on the film, the peaks of the microstructures 103 may be worn away as illustrated in the flow chart. The result is a flat portion 110 or 120 that is barren of any nanocavities and/or nanofeatures (or particles, as the case may be), and will suffer a lower degree of hydrophobicity. The present description aims to provide a solution to these issues, and further provide a superhydrophobic film that is highly durable.

In order to compete against this effect, the present description aims to preempt the wearing away of microstructures, and consequently, nanofeatures in or on those microstructures, or nanoparticles on those microstructures. As such, the present description provides for a microstructured film where at least some of the microstructures are truncated to provide a flat surface. This allows for a distribution of external forces (e.g. abrasion) over a larger area of the surface of the microstructures, resulting in a smaller force per area, such that the height of microstructures may be maintained, and the nanoparticles and nanofeatures may be preserved at greater length, providing for greater performance.

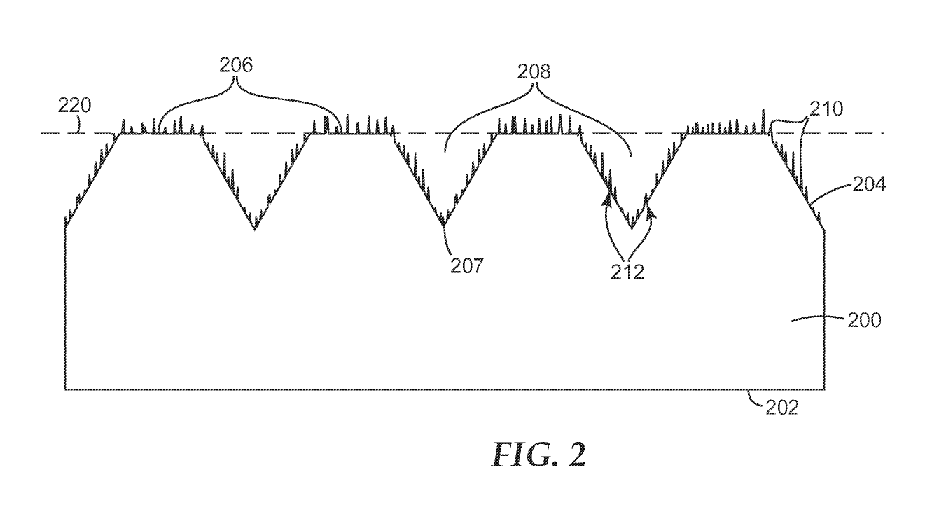

One embodiment of a film according to the present description is illustrated in FIG. 2. As shown in FIG. 2, superhydrophobic film 200 has a first major surface 202. The first major surface 202 may be flat as illustrated in the figure. In other embodiments, the surface may have slight matte variation or microstructures, but in such cases, the film may generally be understood as having an average height that lies in a flat plane. The superhydrophobic film 200 also has a second major surface 204 that is opposite the first major surface 202. The second major surface may be understood as being made up of at least two different sub-parts. The first subpart of the second major surface is an array of discrete flat surface portions 206. Each of the discrete flat surface portions 206 is substantially parallel to the first major surface 202. As mentioned above, generally the first major surface 202 will be flat. However, where there is slight variation in the surface, the flat discrete portions will lie parallel to the flat plane that is the average height of first major surface 202.

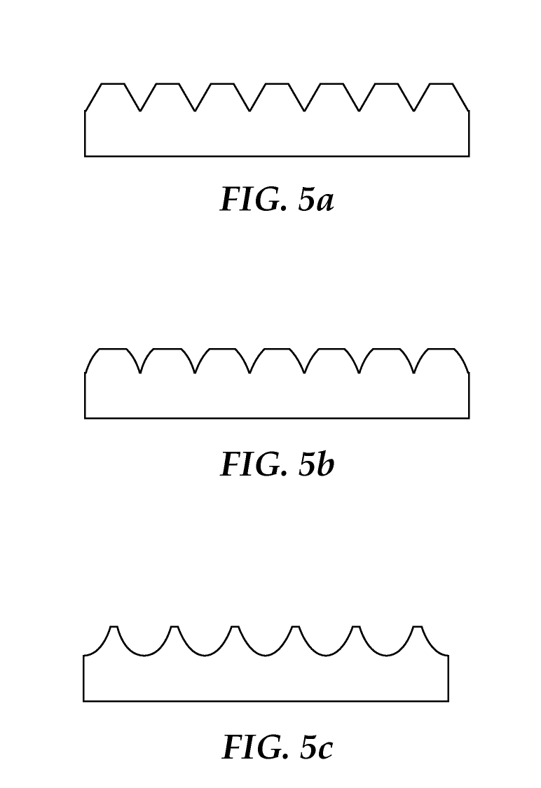

The second subpart of second major surface 204 is an array of valleys 208. Each valley 208 in the array of valleys is positioned between adjacent discrete flat surface portions 206. In FIG. 2, the valleys 208 are shown as having facets that terminate at a common point 207. However, valleys are also contemplated that have flat or near-flat bottoms of the valley, as well as side facets of microstructures that have sudden discontinuities in slope. Further, the valleys may have side walls 212 that are flat, as shown in FIG. 2. In other embodiments, the side walls 212 may be curved, such as in a portion of a microlens. Examples of just a few different shapes that valleys may take according to the present description are illustrated in FIGS. 5a-5c. Specifically, the valley may have flat side walls as illustrated in FIG. 5a, or may have curved sidewalls that are concave down, such as shown in FIG. 5b. The side walls may also be curved and concave up, as illustrated in FIG. 5c. A number of other valley shapes are also contemplated.

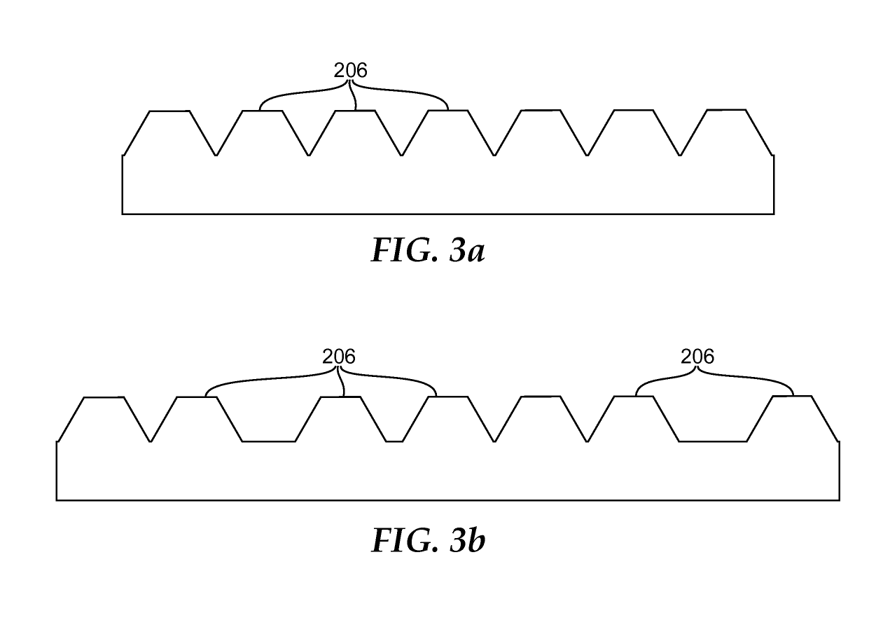

In addition, as illustrated in FIG. 3a-b the discrete flat portions 206 may be spaced apart in a constant periodic manner, as shown in FIG. 3a, or may be variably spaced apart at different distances along the second major surface, as illustrated by flat portions 206 in FIG. 3b.

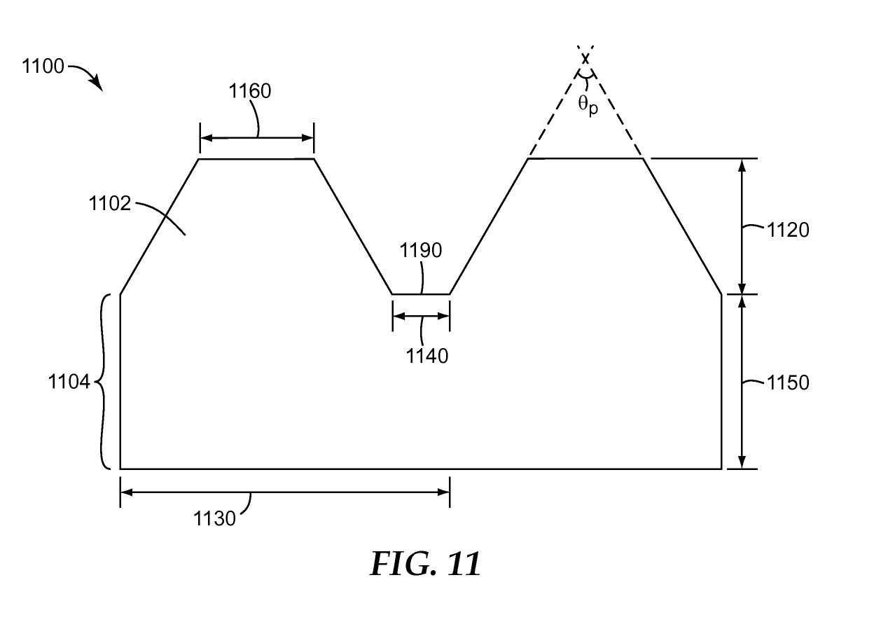

A better understanding of the dimensions of microstructures according to the present description may be gained by reference to FIG. 11 and film 1100. In a number of embodiments, the structured film will be made up of microstructures 1102, and that portion below the microstructures that is a solid portion of the film that connects and stabilizes the film without varying structure. This portion may be understood as “land” 1104. The land generally should be of a sufficient thickness to generate stability for the entire film. The land, for example may have a thickness 1150 than is at least greater than 25 microns, and often greater than 100 microns. The microstructures may have a height 1120 that is either the distance from land 1104 to the plateau or peak at which the top of the microstructure 1102 terminates. The height 1120 of microstructure 1102 may generally range from about 0.150 microns to about 1000 microns, or potentially from about 1 micron to about 500 microns. In general, at least some of the microstructures will be truncated such that they have a plateau at the peak of the microstructure. The plateau generally will have a lateral distance 1160 across the plateau (or discrete flat surface portion) of between about 0.1 microns up to about 20 microns. In addition, the film 1100 may have a pitch that is defined as the distance between adjacent microstructures 1102. Generally, the pitch of a microstructured film according to the present description is between about 0.15 microns and about 1000 microns, or potentially between about 1 and about 500 microns. The film 1100 is also made up of valleys that have bases 1190. The distance across the valley base 1140 may of course be as small as 0 microns, but may also range up to 100 microns. In fact, in some embodiments, the distance across the valley base may be up to four times the height of the microstructures. Where the microstructures utilized are prisms rather than a variable sloped microstructure (e.g. a lens), any number of peak angles θ_{P} are considered useful. For example, peak angle θ_{P} may range in some embodiments from about 30 degrees to about 90 degrees. In many embodiments, the peak angle will range from about 50 degrees to about 70 degrees.

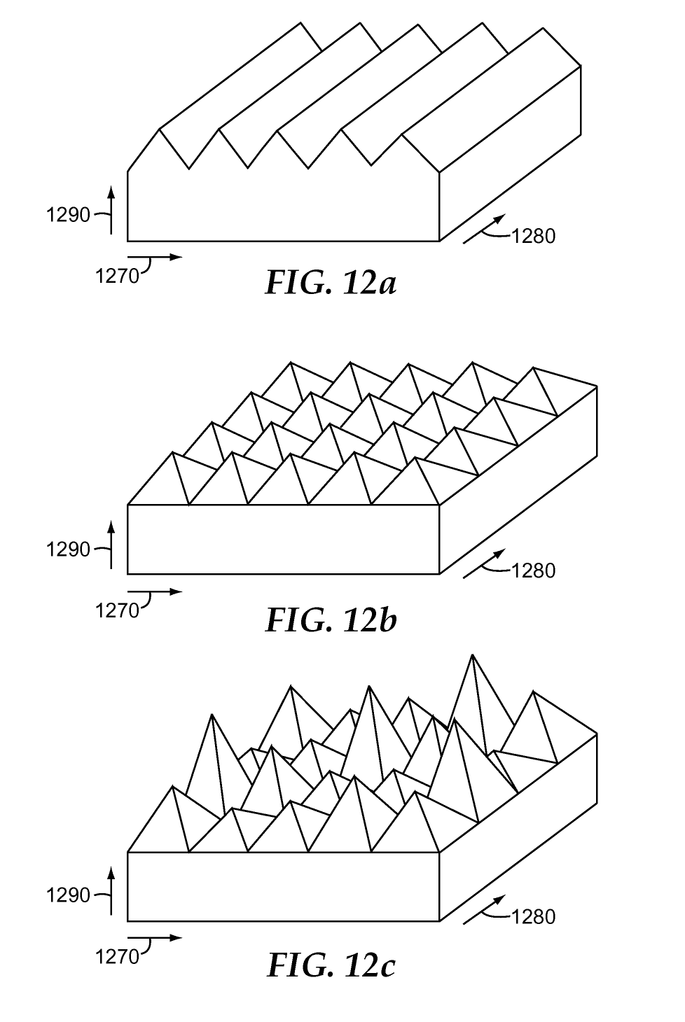

In addition, microstructure placement and dimensions may vary across the surface of the film. A better understanding of this may be gained by reference to FIGS. 12a-c, which illustrate an array of microstructures, shown here without any truncation. For example, an array of microstructures (shown here without any truncation) may vary in one, two or three dimensions. In FIG. 12a, the microstructures may be structures that identically run the length 1280 of the film at the same height along the vertical direction 1290 without any segmentation. However, across the width 1270 of the film 1270, or across a first dimension, the film is segmented into different discrete microstructures. In addition, as shown in FIG. 12b, the microstructure may vary in two directions. For example, the structures may be segmented as in FIG. 12a along the width 1270 of the film, but also be segmented along the length 1280 of the film (or second dimension). In such a case, discrete prisms are located along both axes. Here, however, the structures are all the same height in the vertical direction (or third dimension) 1290. Finally, as shown in FIG. 12c, the structures may be segmented along both the width and length of the film, but may also vary in the height of the microstructures across the film in the vertical direction 1290 (or third dimension). In any of these three scenarios the microstructures may be directly adjacent to one another or may be spaced apart by some portion of film that is flat. Of course, although illustrated here with respect to various prismatic embodiments, the microstructures may be lens shaped, or any other suitable structure.

Returning to FIG. 2, the second major surface 204 may include microstructures on the second major surface that do not have discrete flat portions. An example of such a construction is illustrated in FIG. 10 with film 1000. In this construction there are discrete flat surface portions 1006. In one respect the discrete flat surface portions 1006 are the tops of truncated microstructures 1003a. Two adjacent discrete flat surface portions 1006a and 1006b are separated by a single valley 1008a. The same is true with discrete flat surface portions 1006c and 1006d, as separated by valley 1008b. However, as they are the two closest discrete flat surface portions to one another, portions 1006b and 1006c may be considered adjacent flat surface portions. They too are separated by a valley, and in fact multiple valleys, see valleys 1008c and 1008d. However, the discrete flat surface portions may also be separated by smaller microstructures 1003b. These smaller microstructures will generally be shorter than the height of the plane 1020 upon which the discrete flat surface portions 1006 commonly lie. The microstructures 1003b may terminate at a peak 1080, or may be a lens shape or any other appropriate shape. As discussed below with respect to the valleys and flat surface portions, the microstructures 1003b may also have nanofeatures or nanoparticle coatings. In some embodiments, all of the microstructures 1003a or 1003b will have a discrete flat surface portion 1006. However, in other embodiments, only some of the microstructures will have a discrete flat surface portion. In some embodiments, a majority of the microstructures will have discrete flat surface portions.

Returning to FIG. 2, each of the discrete flat portions 206 also includes a plurality of nanofeatures 210. The valleys 208 also have a plurality of nanofeatures 210 on their surface. The scale of the nanofeatures will generally be much smaller than the depth of valleys 208. The nanofeatures 210 may be protrusions from the surface 204, or may be cavities that enter the surface 204. In either case, however, the nanofeatures will be very thin and optionally fairly long in dimension. For example, the nanofeatures may have an aspect ratio of at least 1 to 1, at least 2 to 1, or at least 3 to 1, or at least 4 to 1, or at least 5 to 1, or at least 6 to 1.

Two of the most important measurements in determining just how superhydrophobic a film or coating is are that of water contact angle and sliding angle (or contact angle hysteresis). The water contact angle may be measured with a static contact angle measurement device, such as the Video Contact Angle System: DSA100 Drop Shape Analysis System from Kruess GmbH (Hamburg, Germany). In this particular system, a machine is equipped with a digital camera, automatic liquid dispensers, and sample stages allowing a hands-free contact angle measurement via automated placement of a drop of water (where the water drop has a size of approximately 5 μl). The drop shape is captured automatically and then analyzed via Drop Shape Analysis by a computer to determine the static, advancing, and receding water contact angle. Static water contact angle may be generally understood as the general “water contact angle” described and claimed herein.

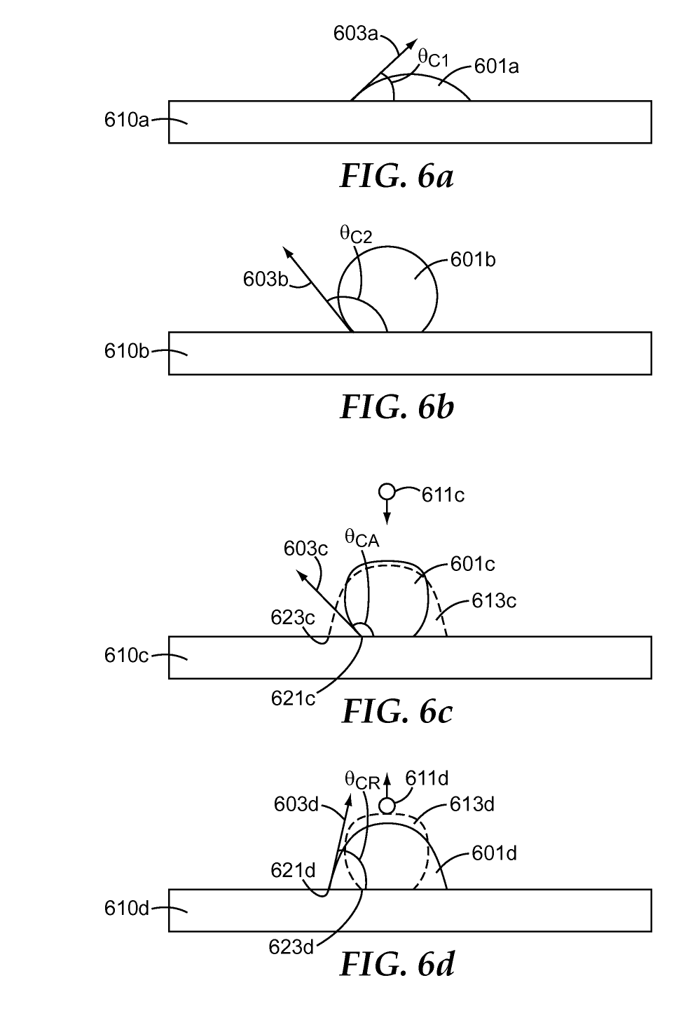

The water contact angle may most simply be understood as the angle at which a liquid meets a solid surface. As shown in FIG. 6a, where a surface of film 610a is not very hydrophobic, the water drop 601a will flatten on the surface. A tangential line 603a may be drawn from interface point of the drop along the edge of the drop. The contact angle θ_{C1} is the angle between this tangent line 603a, and the plane of the drop 601a and film 610a interface. FIG. 6a shows a water droplet that is not beading along the surface and therefore a contact angle θ_{C1} that is well below 90 degrees. Conversely, film 610b in FIG. 6b is hydrophobic. As such, the water droplet 601b experiences more of a beading effect off of the surface. Therefore the tangent line 603b along the drop's edge angles out away from the drop, and a water contact angle θ_{C2} of greater than 90 degrees, and potentially greater than 140 or 150 degrees is achieved.

The “sliding angle” or “contact angle hysteresis” is defined as the difference between the advancing and receding water contact angles. Advancing water contact angle and receding water contact angles relate not just to static conditions, but to dynamic conditions. With reference to FIG. 6c, the advancing water contact angle θ_{CA} is measured by adding further water volume 611c into the drop 601c. As more water is added, the droplet increases in volume and the water contact angle also increases. When a critical volume is reached, the intersection of the droplet surface with the film will jump outward such that droplet 601c will reform into a droplet with shape 613c, and the intersection of the droplet and film surfaces will move from position 621c to position 623c. The water contact angle θ_{CA} is the angle of the drop immediately before the intersection jumps. In the same vein, water receding angle is shown in FIG. 6d. Here the higher volume drop has water 611d slowly removed from it. The surface of initial drop 601d intersects the film 610d at position 621d. At a given volume, the intersection jumps to position 623d. The tangent line 603d that traces the edge of the drop immediately before this jump defines the receding water contact angle θ_{CR}.

Again returning to FIG. 2, the superhydrophobic film 200 also exhibits strong hydrophobic properties. In at least one embodiment, the superhydrophobic film 200 has a static water contact angle of at least 140 degrees, or potentially at least 145 degrees or even over 150 degrees. The superhydrophobic film 200 also has a sliding angle of less than 10 degrees or less than 5 degrees, and potentially even less than about 3 degrees.

As stated, the second major surface 204 has an array of discrete flat portions 206, each of which is covered in nanofeatures 210. The discrete flat portions serve to spread the amount of incident force upon the film over a larger surface area. As such, the surface 204 is more difficult to degrade and nanofeatures 210 and flat portions 206 may remain intact, at least for a longer exposure time. Because of this desire to spread force across the discrete flat portions, in at least some embodiments, it is beneficial for the discrete flat portions to be positioned on a common plane 220. It should be understood that film 200 may be made out of any number of suitable materials. In some embodiments, the film 200 may be made in part of a silicone polymer, such as poly(dimethylsiloxane) (PDMS). The film may be a majority by weight PDMS or potentially even up to or greater than 95 wt. % PDMS. In some embodiments, the film 200 may be made of a silicone polymer in which some of the silicon atoms have other groups that may be aryl, for example phenyl, alkyl, for example ethyl, propyl, butyl or octyl, fluororalkyl, for example 3,3,3-trifluoropropyl, or arylalkyl, for example 2-phenylpropyl. The silicone polymers may also contain reactive groups, such as vinyl, silicon-hydride (Si—H), silanol (Si—OH), acrylate, methacrylate, epoxy, isocyanate, anhydride, mercapto and chloroalkyl. These silicones may be thermoplastic or they may be cured, for example, by condensation cure, addition cure of vinyl and Si—H groups, or by free-radical cure of pendant acrylate groups. They may also be cross-linked with the use of peroxides. Such curing may be accomplished with the addition of heat or actinic radiation. Other useful polymers include polyurethanes, fluoropolymers including fluororelastomers, polyacrylates and polymethacrylates. In another embodiment, polymers with a glass transition temperature of at least 25 degrees C. are useful. In at least some embodiments, the film may be an elastomer. An elastomer may be understood as a polymer with the property of viscoelasticity (or elasticity) generally having notably low Young's modulus and high yield strain compared with other materials. The term is often used interchangeably with the term rubber, although the latter is preferred when referring to cross-linked polymers.

In addition, the film according to the present description may be positioned on a substrate. The film will generally be positioned such that the first major surface is adjacent the substrate. The substrate may be made from any number of suitable materials. For example, in some embodiments, the substrate may be made from the same materials as the film. In other exemplary embodiments, the substrate may be made of polyimide or more commonly used substrates. Specifically, glass, metal or plastic substrates may be appropriate, as well as other suitable alternatives such as silicon wafers.

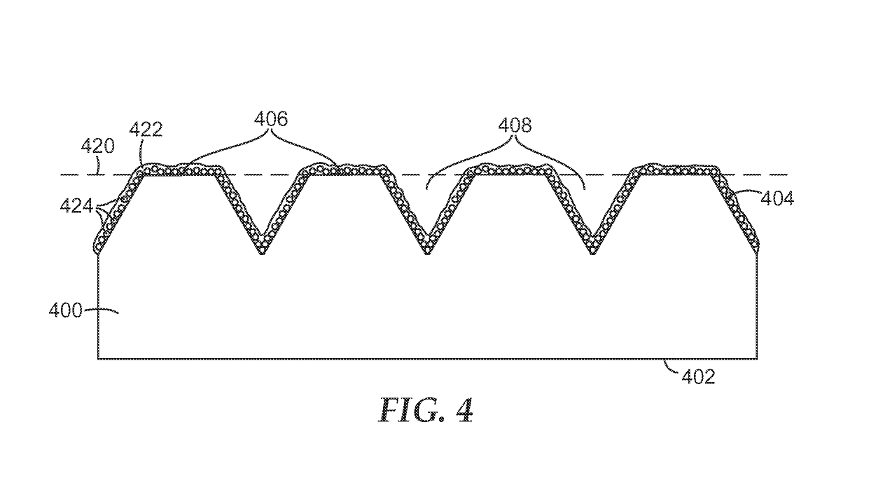

Another embodiment of a superhydrophobic film contemplated according to the present description is illustrated in FIG. 4. FIG. 4 provides a superhydrophobic film 400 that has a first major surface 402. The first major surface 402 may be provided in the same manner as first major surface 202 of FIG. 2. Opposite the first major surface 402 on the film 400 is a second major surface 404. The second major surface may include an array of discrete flat surface portions 406, and an array of valleys 408. Each valley may be positioned between two adjacent discrete flat surface portions. As with the film described in FIG. 2, the discrete flat surface portions 406 may in at least some embodiments be located on a common plane 420 such that force is distributed evenly along the faces of the second surface 404. Also as with the film described in FIG. 2, the film may further include microstructures (e.g. 1003b in FIG. 10) that are also placed between discrete flat surface portions, along with the valleys in between such portions.

A low surface energy coating 422 is applied over the discrete flat surface portions 406 and valleys 408. A low surface energy coating may generally be understood as a coating that, on a flat surface, has a water contact angle of greater than 110 degrees. The low surface energy coating may also be coated over any non-truncated microstructure 1003b that does not terminate in a discrete flat surface portion. The low surface energy coating 422 exhibits hydrophobic properties that, in conjunction with the structure of film 400 contribute to the heightened superhydrophobicity of the film. The low surface energy coating may be any known hydrophobic coating, such as a nanocomposite coating. In some cases, the nanocomposite coating could be, at least in part, a fluorochemical coating. In some cases, the low surface energy coating may be made up of an appropriate silane, e.g. fluoroalkyl substituted silane. In at least some embodiments, the low surface energy coating 422 is made up in part, and potentially in large part, to a plurality of nanoparticles 424. The nanoparticles 424 may be of a polymer, such as a fluoropolymer, a dielectric, such as silicon dioxide, ZrO₂, Al₂O₃, TiO₂, CeO₂, ITO, or a metal, such as gold. The nanoparticles may be of a size from about 5 nm to 1 micron. In some embodiments, the low surface energy coating may include, in part, an adhesion promoter to further increase durability and better hold the coating on the surface portions 406 and valleys 408. In other exemplary embodiments, an adhesion promoter may be applied separately from the low surface energy coating. One example of such an adhesion promoter is a silane, such as SILQUEST A-1106, available from Momentive Performance Materials, Inc. (Wilton, Conn.). Exemplary fluoropolymers and adhesion promoters that may be particularly useful for the low surface energy coating currently described may be found in commonly owned and assigned U.S. Pat. No. 7,323,514 in the section beginning at col. 5, line 5 and concluding at column 10, line 42. U.S. Pat. No. 7,323,514 is hereby incorporated herein by reference in its entirety.

Where nanoparticles are applied as part of a coating, the nanoparticles may also have surface treatment agents applied over them. Exemplary surface treatment agents include N-(3-triethoxysilylpropyl) methoxyethoxyethoxyethyl carbamate, N-(3-triethoxysilylpropyl) methoxyethoxyethoxyethyl carbamate, 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl) methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate (BCEA), 2-(2-methoxyethoxy)acetic acid, methoxyphenyl acetic acid, and mixtures thereof.

The superhydrophobic film 400 also exhibits strong hydrophobic properties. In at least one embodiment, the superhydrophobic film 200 has a water contact angle of at least 140 degrees, or potentially at least 145 degrees or even over 150 degrees. The superhydrophobic film 200 also has a sliding angle of less than 10 degrees or less than 5 degrees, and potentially even less than about 3 degrees.

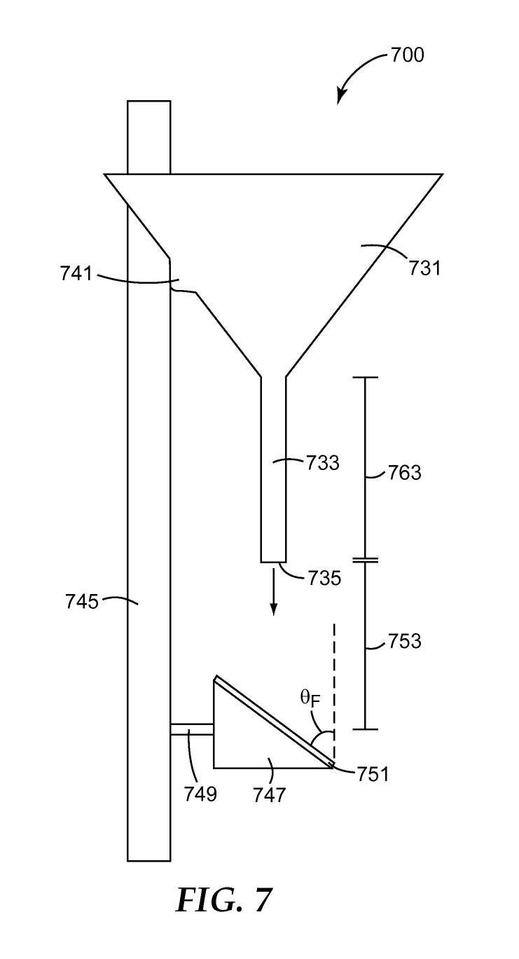

One of the primary improvements of the current film over the art is the durability exhibited by the film. In order to gauge the ability of films to withstand exposure to the elements, it is valuable to expose them to a test condition setting that provides a simulation of the elements. One standard approach for such a simulation is called a falling sand test or falling sand exposure test (as in ASTM standard D 968). The durability of the films according to the present description was tested by dropping a given volume of sand over a predetermined amount of time at a given distance and angle from the surface of the film. FIG. 7 provides a general illustration of the apparatus 700 used to test the films by falling sand. In one exemplary test one kilogram of standardized sand is placed in reservoir 731. Reservoir 731 is connected to a support beam 745 by first connecting means 741. A given amount of sand constantly moves from reservoir 731 into tube 733. It falls within the tube 733 a distance 763 of 90 cm. The steady stream of sand then exits tube 733 at tube exit 735 and travels toward film 751. Film 751 is securely positioned beneath the stream of sand by film support structure 747. The film support structure may also be positioned in place by securing to support beam 745 through second connecting means 749. The film support structure 747 positions the film such that the plane of the film is at a 45 degree angle with the primary direction of the stream of sand. Therefore, with reference to FIG. 7, the angle θ_{F} is 45 degrees. The primary contact point on film 751 may be placed a predetermined distance 753 from the tube exit 735 having a diameter of 2 cm. In this test, the distance 753 is 25 mm.

The “falling sand” test performed as specified above generally will create a great deal of abrasion on the surface of a film, especially with a film that is microstructured and/or nanofeatured. As such, it is to be expected that most superhydrophobic film constructions in the art that had to go through the test would see serious degradation to the structures on the film's surface. This would necessarily result in lower hydrophobicity (i.e. lower water contact angles and high sliding angles).

The films described above exhibit superhydrophobic properties even after exposure to the falling sand test herein described. For example, after exposure to the falling sand test, the water contact angle of such a film may be greater than 140 degrees, or even greater than 145 degrees. The sliding angle may remain below 5 degrees, and potentially be even less than 3 degrees.

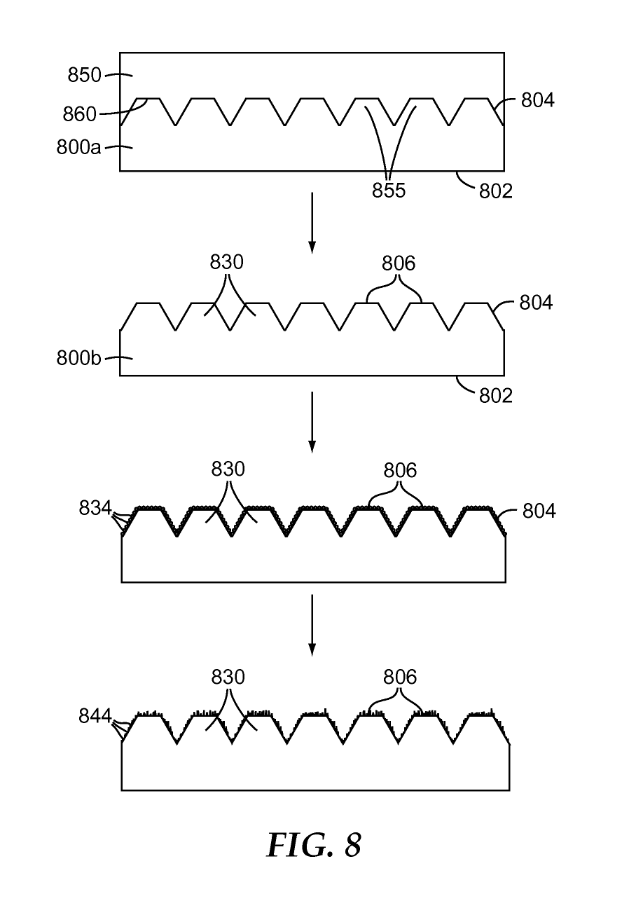

The present description also relates to methods of creating superhydrophobic films. One such method of creating a superhydrophobic film is illustrated in the flow chart according to FIG. 8. The method may in some embodiments begin with providing a structured film 800b. The structured film 800b has a first major surface 802 and a second major surface 804 that is opposite the first major surface 802. On the second major surface 804 are a plurality of microstructures 830. The microstructures may be periodically spaced, as illustrated in FIG. 8 and also as shown in FIG. 3a. The microstructures may also be variably spaced as illustrated in FIG. 3b. The microstructures shape (closest to the base) may be prisms, as illustrated in FIG. 8, microlenses, a pattern that mimics sharkskin, or any other suitable microstructure shape. On top of at least some of the plurality of microstructures 830 are discrete flat portions 806. Discrete flat portions may be located on a majority of microstructures 830 or all of the microstructures. Where the microstructures are shorter than the plane upon which the discrete flat surface portions lie, the tops of the microstructures may still terminate in a peak, or lens shape, or other appropriate shape. An example would be those microstructures 1003b in FIG. 10, where the peaks or tops 1080 of the microstructures are not as tall as plane 1020. The discrete flat portions 806 may generally be understood as substantially parallel to the first major surface 802. Where, as described with respect to FIG. 2, there are slight variations, the flat portions 806 may be understood as being substantially parallel to the average plane of the first major surface 802.

Another step may be understood as part of this method that occurs before the structured film is present. The structured film may be formed through some sort of replication process. This also may be understood as the first step of FIG. 8. There, a mold is provided. The mold may be made out of any suitable material, such as a metal, e.g. nickel, or a polymer, to name a few. The mold is made up in part of a plurality of valleys 855. At least some of these valleys 855 will have a flat base 860. A composition 800a may be applied to the mold 850. The composition may be made up of any of the materials mentioned with regard to the structured film material above, e.g. a silicone polymer such as PDMS, a polyurethane, polyacrylate, or any of the other large number of materials noted above. The composition may next cured and then removed from the mold creating a negative of the mold, such that the flat bases 850 of valley 855 correspond to the discrete flat surface portions 806 on cured film 800b.

In the next step of the method according to FIG. 8, after providing the structured film 800b, a layer of nanoparticles 834 may be applied to the second major surface 804. The layer of nanoparticles should cover the entire second major surface 804, such that it covers flat portions 806 and those valley portions of microstructures 830 in between flat portions 806, as well as any potential flat portions that are located in valleys between microstructures or on microstructures in between the flat portions. Generally, the nanoparticles may be made up of any material that is conducive to serving as an etch mask for the film. For example, the nanoparticles may be a slow-etching metal such as gold, or certain metal oxides, e.g., indium tin oxide, ZrO_{2, CeO}_{2, Al}₂O₃, or TiO₂, just to name a few. The particles may be applied as part of a binder or coating suspension as desired to best disperse the particles on the surface 804. The nanoparticles may be applied to the second major surface by any appropriate coating method, such as dip coating, roll coating, die coating, spray coating, spin coating, and the like. Coating method, equipment, process conditions and compositions may be selected to achieve a substantially uniform coating over surfaces 804 and 806.

In the subsequent step, the second major surface 804 is etched using the nanoparticles 834 as an etch mask. One particularly useful etching method for the etching step is reactive ion etching. Dry etching techniques such as laser ablation or ion beam milling may also be used. The result of the etching step is a plurality of nanostructures 844 that are located on the discrete flat portions 806, and remainder of microstructures 830 and any portions of surface in between them. The nanostructures may be broadly understood in the current description as either nanofeatures that protrude from the surface of microstructures 830, or valleys that are etched into the surface of microstructures 830. Where the nanoparticles used are slow-etching they may create either nanostructure valleys or protrusions that have high aspect ratios, such as 2 to 1, 3 to 1, 4 to 1, 5 to 1, 6 to 1 or even greater.

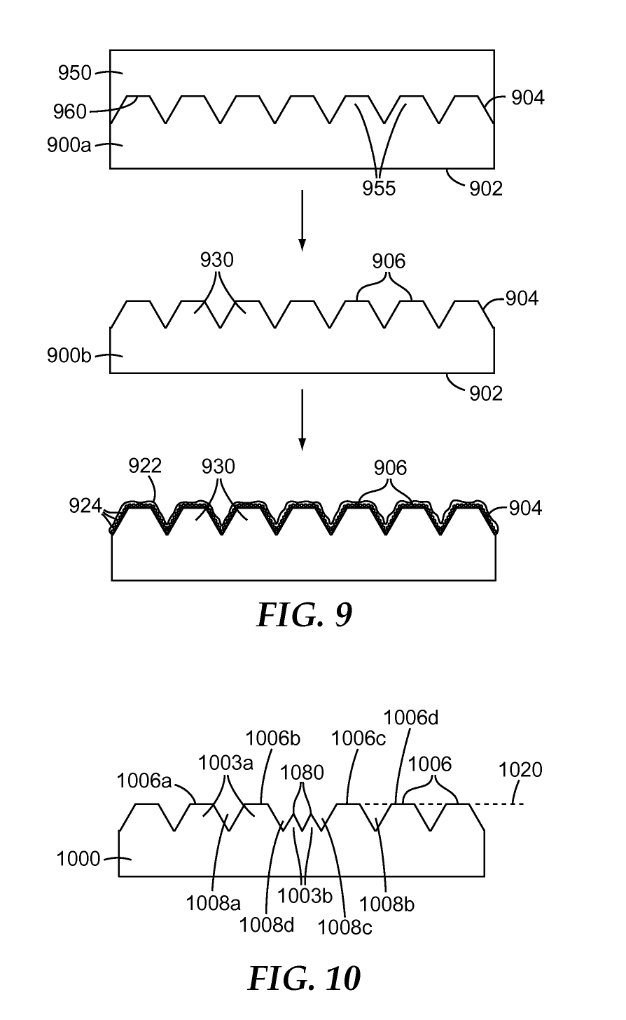

Another method for creating a superhydrophobic film according to the present description is provided in FIG. 9. The method may begin with providing a structured film 900b. The structured film 900b may have a first major surface 902 and a second major surface 904. The second major surface is opposite the first major surface 902 and includes a plurality of microstructures 930. The microstructures may be periodically spaced, as illustrated in FIG. 9 and also as shown in FIG. 3a. The microstructures may also be variably spaced as illustrated in FIG. 3b. The microstructures may be prisms, as illustrated in FIG. 9, microlenses, a pattern that mimics sharkskin, or any other suitable microstructure shape. On top of at least some of the plurality of microstructures 930 is a discrete flat portion 906. Discrete flat surface portions may be located on a majority or all of the microstructures. Where there are microstructures that are potentially shorter those microstructures may not have their peaks or tops 1080 flattened. The discrete flat portions are generally substantially parallel to the first major surface 902.

Another step may be understood as part of this method that occurs before the structured film is present. The structured film may be formed through some sort of replication process. This also may be understood as the first step of FIG. 9. There, a mold is provided as described with respect to FIG. 8 above. The mold is made up in part of a plurality of valleys 955. At least some of these valleys 955 will have a flat base 960. A composition 900a may be applied to the mold 950. The composition may be made up of any of the materials mentioned above with regard to the method of FIG. 8 or articles above described. The composition may next cured and then removed from the mold creating a negative of the mold, such that the flat bases 950 of valley 955 correspond to the discrete flat surface portions 906 on cured film 900b.

Finally, in the final step of the method of FIG. 9, after providing the structured film, a fluorochemical coating 922 may be applied to the second major surface 904. The fluorochemical coating should be applied to the entire second major surface 904, such that it covers both discrete flat portions 906 and the other portions of microstructures 930, as well as any portions of second major surface 904. The fluorochemical coating may generally be a hydrophobic, low surface-energy coating as described above in relation to FIG. 4. In some embodiments, the fluorochemical coating will be made up, at least in part, by a plurality of nanoparticles. As discussed with the article described with respect to FIG. 4, the nanoparticles may potentially be made up of a dielectric, such as silicon dioxide. In other embodiments, the nanoparticles may be fluoropolymer particles. The fluorochemical coating may further include an adhesion promoter, such as a silane as discussed with respect to FIG. 4.

In any of the methods that are shown in FIG. 8 and FIG. 9, the amount of prisms having discrete flat portions on the highest portion of the microstructures may be different, although each embodiment according to the present description will have at least some prisms having a truncated top, such that it has a discrete flat surface for a top. For example, looking to FIG. 10, and film 1000, some of the films of FIGS. 8 and 9, as well as those described in the articles described with respect to FIGS. 2 and 4, the film 1000 may have microstructures 1003a that have discrete flat portions 1006 on top of each microstructure 1003a. However, the film 1000 may also have microstructures 1003b on the film that do not terminate with a discrete flat portion, but rather terminate as a peak 1080 or in some other fashion. For each of the embodiments described herein, there are at least some discrete flat portions (e.g. 206 in FIG. 2) that rise to a common plane 220. However there may be other microstructures on second major surface 204 (e.g. structures 1003bin FIG. 10) that are shorter than the plane at which the discrete flat portions lie. Weight and force may still be distributed across the microstructures 1003a having discrete flat portions 1080, while those microstructures that are shorter 1003b do not bear the weight.

### EXAMPLES

### Example 1

A silica nanoparticle coating component was prepared. In a 1 L flask, equipped with a condenser and a thermometer, 300 g of Nalco 2329K (40 wt. % solid), available from Nalco Chemical Company (Naperville, Ill.), and 300 g of isopropanol were mixed together under rapid stirring. Next, 7.96 grams of SILQUEST A-174 was added, and the mixture was stirred for 10 minutes. The mixture was heated to 85° C. using a heating mantle for 6 hours. Finally, the resultant reaction mixture was solvent exchanged into methyl isobutyl ketone by alternate vacuum distillation and addition of 2600 grams of Methyl Isobutyl Ketone. The batch was concentrated further by vacuum distillation. The final mixture was a slightly translucent dispersion with 35.4% by weight A-174 modified 98 nm.

100 g of Dyneon™ FPO 3740 and 400 g of MEK was added to a brown bottle. The polymer was dissolved under ultrasonic treatment, which yielded a clear DYNEON FFO 3740 solution in MEK with 20% wt solid.

“HFPO—”, as used in the examples, unless otherwise noted, refers to the end group F(CF(CF₃)CF₂O)aCF(CF₃)— of the methyl ester F(CF(CF₃)CF₂O)aCF(CF₃)C(O)OCH₂. (HFPO—C(O)CH₃), wherein “a” averages about 6.84, with an average molecular weight of 1314 g/mol. It was prepared according to the method reported in U.S. Pat. No. 3,250,808 (Moore et al.), incorporated herein by reference, with purification by fractional distillation.

HFPO-Urethane acrylate solution (30% wt in methyl ethyl ketone) was prepared according to the method described in U.S. patent application Ser. No. 11/277,162, incorporated herein by reference.

The coating solution was prepared by mixing all the gradients listed in Table 1 under stirring to form a homogenous solution.

TABLE 1
98 nm Silica Nanoparticle Coating

| | | % solid as | Amount |
|---|---|---|---|
| Materials | Supplier | supplied | (grams) |
| A-174 modified | | 35.4% wt in | 10-20 |
| 2329K silica | | PM | |
| DYNEON FPO | | 20% in MEK | 5-15 |
| 3740 | | | |
| HFPO- | | 30% wt in | 0-5 |
| Urethane | | MEK | |
| Acrylates | | | |
| SR350 | Satomer, Exton, | 100% | 4.29 |
| | PA | | |
| MEK | | | 80-150 |
| IRGACURE | Ciba Specialty | 100% | 0.1-0.8 |
| 184 | Chemicals, | | |
| | Basel, | | |
| | Switzerland | | |

The mixture was prepared by mixing the entire gradient together under rapid stirring.

After mixture, the silica nanoparticle coating was applied on top of a comparative prismatic film in which the prisms were spaced apart at a periodic pitch of 44 μm. The mixture was dried on the film in air for 15 minutes, and then cured using a Fusion Light-Hammer 6 UV processor available from UV Systems Inc. (Gaithersburg, Md.) that was equipped with an H-bulb, operating under nitrogen atmosphere at 85% lamp power at a line speed of 13.7 meters/min. (2 passes).

Next, a prismatic film of the same dimensions as the comparative film except for having truncated tops was provided. In the first prismatic film there were a series of peaks that extend from the base of the microstructure an average of 21.3 μm. The second prismatic film had a series of microstructures in which the top terminates at a flat portion. The distance from the base of the microstructures to the flat portion was an average of 16.5 mm (an average of 4.8 μm removed). The silica nanoparticle coating described above was then applied to the second prismatic film (the truncated prismatic film) in the same manner as described above on the prismatic film. The water contact angle of each of the films, the prismatic film with coating, and the truncated prismatic with coating, was then measured.

Following this performance measurement, each of the two films was subjected to the ASTM falling sand test as explained further above in the description. The water contact angle of the two films was again tested. Table 2 provides the performance results.

TABLE 2
Water Contact Angle after Durability Test

| | Initial Water Contact | Water Contact Angle |
|---|---|---|
| Sample | Angle | after Falling Sand Test |
| Comparative Normal | 148.7° | 138.4° |
| Prism Structure (44 μm | | |
| pitch) with Coating | | |
| Truncated Prism | 148.6° | 145.6° |
| Structure (30 μm pitch) | | |
| with Coating | | |

As shown in Table 2, initially the superhydrophobic properties of the two films were nearly identical, with water contact angles of 148.7° and 148.6° respectively. However, after durability testing, the water contact angle of the prism film with no truncation of the peak was reduced below 140° to 138.4°. The truncated prism structure still had strong superhydrophobic performance after the test, with a water contact angle of 145.6°. The example provides a valuable illustration of the ability of the films of the current description to remain highly superhydrophobic despite harsh environmental conditions and abrasion experienced in a number of real-world applications.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A superhydrophobic film, comprising:
a first major surface; and
a second major surface opposite the first major surface, the second major surface comprising an array of discrete flat surface portions, wherein each of the discrete flat portions is substantially parallel to the first major surface; and the second major surface further comprising an array of valleys, wherein at least one valley is positioned between adjacent discrete flat surface portions,
wherein each of the discrete flat surface portions and valleys comprises a plurality of nanofeatures, and
wherein the superhydrophobic film has a water contact angle of at least 140 degrees and a sliding angle of less than 10 degrees.

2. (canceled)

3. The superhydrophobic film of claim 1, wherein the valleys have flat side surfaces.

4. The superhydrophobic film of claim 1, wherein the valleys have curved side surfaces.

5. The superhydrophobic film of claim 1, wherein the film has a water contact angle of at least 150 degrees and a sliding angle of less than 5 degrees.

6. (canceled)

7. The superhydrophobic film of claim 1, wherein the film is made of a polymer that is at least 95% PDMS.

8. The superhydrophobic film of claim 1, wherein the nanofeatures have an aspect ratio of at least 5 to 1.

9. The superhydrophobic film of claim 1, wherein the discrete flat portions are periodically spaced apart.

10. The superhydrophobic film of claim 1, wherein the discrete flat portions are variably spaced apart.

11. (canceled)

12. A superhydrophobic film, comprising:
a first major surface;
a second major surface opposite the first major surface, the second major surface comprising an array of discrete flat surface portions, wherein each of the discrete flat portions is substantially parallel to the first major surface; and the second major surface further comprising an array of valleys, wherein at least one valley is positioned between adjacent discrete flat surface portions; and
a low surface energy coating, the low surface energy coating applied to the array of discrete flat surface portions and array of valleys, wherein the low surface energy coating comprises nanoparticles,
wherein the superhydrophobic film has a water contact angle of at least 140 degrees and a sliding angle of less than 10 degrees.

13. The superhydrophobic film of claim 12, wherein the discrete flat portions are positioned on a common plane.

14. The superhydrophobic film of claim 12, wherein the low surface energy coating comprises fluoropolymer.

15. The superhydrophobic film of claim 12, wherein the film has a water contact angle of at least 150 degrees and a sliding angle of less than 5 degrees.

16. (canceled)

17. The superhydrophobic film of claim 12, wherein the superhydrophobic film comprises an adhesion promoter.

18. (canceled)

19. A method of producing a superhydrophobic film, comprising:
providing a structured film, the structured film having a first major surface and a second major surface opposite the first major surface, the second major surface comprising a plurality of microstructures, where at least some of the microstructures have a discrete flat portion on the top of the microstructures, the discrete flat portions being substantially parallel to the first major surface;
applying a layer of nanoparticles to the second major surface; and
etching the second major surface using the layer of nanoparticles as an etch mask, resulting in a plurality of nanostructures on the discrete flat portions and remainder of the microstructures.

20. (canceled)

21. The method of claim 19, wherein the nanoparticles are metal oxide nanoparticles.

22. (canceled)

23. The method of claim 19, wherein the microstructures are microprisms.

24. The method of claim 19, wherein the microstructures are microlenses.

25. The method of claim 19, wherein the microstructures are periodically spaced.

26. The method of claim 19, wherein the microstructures are variably spaced.

27. The method of claim 19, wherein all of the microstructures have a discrete flat portion on the top of the microstructure.

28-33. (canceled)
